(19) United States
(12) Patent Application Publication
(10) Pub. No.: US 2009/0025517 A1
(43) Pub. Date: Jan. 29, 2009

(54) TORQUE SENSOR INSERTION AND DEINSERTION TOOLS

(75) Inventors: Seiji FUKUI, Osaka (JP); Shinji KAWAMURA, Osaka (JP)

Correspondence Address: GLOBAL IP COUNSELORS, LLP, 1233 20TH STREET, NW, SUITE 700, WASHINGTON, DC, 20036-2680, US

(73) Assignee: SHIMANO INC., Osaka (JP)

(21) Appl. No.: 11/828,555

(22) Filed: Jul. 26, 2007

(51) Int. Cl. B25B 27/14

(52) U.S. Cl. 81/57.34; 73/866.5; 81/488

(57) ABSTRACT

A torque sensor insertion tool is provided for installing a torque sensor disposed on an axle and a torque sensor deinsertion tool is provided for removing a torque sensor unit disposed on the axle. These tools are designed to avoid applying an excessive tension force or an excessive compression force that will distort the torque sensor unit during installation and removal of the torque sensor unit disposed on the axle. Basically, the tools contact the torque sensor at two axially spaced apart points and support the torque sensor unit both internally and externally during installation and removal. The torque sensor insertion tool basically has an axle attachment structure, a tubular sensor supporting structure and a tubular sensor moving structure. The torque sensor deinsertion tool basically has an outer member, an inner member and a nut member.

### BACKGROUND OF THE INVENTION

1. Field of the Invention

This invention generally relates to tools for installing and removing a torque sensor onto an axle. More specifically, the present invention relates to a torque sensor insertion tool for installing a torque sensor onto a crank axle in a bottom bracket of a bicycle frame and a torque sensor deinsertion tool for removing a torque sensor onto a crank axle in a bottom bracket of a bicycle frame.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. Recently, bicycles have been provided with cycle computers to inform the rider of various traveling conditions of the bicycle.

Bicycles are sometimes equipped with a torque sensor (e.g., a torque-detecting device) for detecting torque acting on an axle. One example of a torque sensor that is being developed uses magnetostrictive effects wherein magnetic force varies according to strain (see Japanese Laid-Open Patent Application Nos. 3-269330 and 2001-289720, for example).

The torque sensor disclosed in Japanese Laid-Open Patent Application No. 3-269330 has two solid shafts disposed concentrically, a thin cylindrical shaft connected in series between the two solid shafts, and a detection coil disposed on the external periphery of the thin cylindrical shaft. The thin cylindrical shaft has an effective surface area that is sufficiently smaller than that of the two solid shafts, and the solid shafts are magnetized in one direction along an axial core line. Magnetostrictive elements are affixed to the external peripheral surface of the thin cylindrical shaft. Two magnetostrictive elements are used, and these elements have uniaxial magnetic anisotropy so that their easy magnetization axes intersect. Disposing the magnetostrictive elements on the thin cylindrical shafts in this manner makes it possible to increase the amount of strain created in the magnetostrictive elements and to increase the sensitivity of detection even in cases in which the rotational torque is small.

In Japanese Laid-Open Patent Application No. 2001-289720, the torque sensor is disclosed as having a sleeve with a magnetostrictive pattern formed in the external peripheral surface by inclining magnetostrictive members towards the core, a torque transmission shaft that fits into the internal peripheral surface of the sleeve, and a detection coil disposed on the external periphery of the sleeve. Concavities and convexities are formed in the external peripheral surface of the torque transmission shaft, and a hollow part is formed in the internal periphery. The sleeve is plastically bonded to the torque transmission shaft by expanding the diameter of the hollow part.

In U.S. patent application Ser. No. ______ (Attorney Docket #SN-US070284), a cylindrical torsion-detecting sleeve member (torque sensor unit) is provided on a crank axle for transmitting a torque applied to the crank axle that is configured to be received inside a bottom bracket. The cylindrical torsion-detecting sleeve member basically includes a pair of cylindrical torque-acting parts, a torsion signal generator and a torsion converter. The cylindrical torque-acting parts are disposed at a first and second locations that are axial spaced apart. The torsion signal generator is disposed axially between the first and second torque-acting parts to at least partially form an external peripheral surface between the first and second torque-acting parts. The torsion converter is operatively disposed between the torsion signal generator and at least one of the first and second torque-acting parts for converting torsion transmitted from the at least one of the first and second torque-acting parts to the torsion signal generator.

In the torsion-detecting sleeve member (torque sensor unit) disclosed in U.S. patent application Ser. No. ______ (Attorney Docket #SN-US070284), the torsion-detecting sleeve member (torque sensor unit) needs to be installed and removed without mechanical distorting torsion-detecting sleeve member. If a strong (press or pull) force is applied to one of the ends of the torsion-detecting sleeve member, then the torsion-detecting sleeve member may change shape and become unusable. Thus, it is somewhat difficult to insert and remove the torsion-detecting sleeve member (torque sensor unit) onto a crank axle.

In view of the above, it will be apparent to those skilled in the art from this disclosure that there exists a need for an improved torque sensor insertion tool for installing a torque sensor unit onto a crank axle in a bottom bracket of a bicycle frame and an improved a torque sensor deinsertion tool for removing a torque sensor unit from a crank axle in a bottom bracket of a bicycle frame. This invention addresses this need in the art as well as other needs, which will become apparent to those skilled in the art from this disclosure.

### SUMMARY OF THE INVENTION

One object of the present invention is to provide a torque sensor insertion tool for installing torsion-detecting sleeve member onto a crank axle in a relatively easy and simply manner without substantially changing its shape.

Another object of the present invention is to provide a torque sensor deinsertion tool for removing torsion-detecting sleeve member onto a crank axle in a relatively easy and simply manner without substantially changing its shape.

In accordance with a first aspect of the invention, a torque sensor insertion tool is provided for installing a torque sensor disposed on an axle. The torque sensor insertion tool of this aspect of the invention basically comprises an axle attachment structure, a tubular sensor supporting structure and a tubular sensor moving structure. The axle attachment structure includes a first guide portion, a sensor supporting portion configured to support an inner surface of the torque sensor, and an axle attachment portion configured to fix the axle thereto. The tubular sensor supporting structure includes a first axial connecting portion, a first sensor abutment surface facing in a first axial direction for contacting a first abutment portion of the torque sensor, and a first tube portion having a first internal bore with an inner width dimensioned relative to an outer width of the axle attachment structure to form a predetermined annular sensor receiving space therebetween for receiving the torque sensor when the axle attachment structure is located in the first internal bore. The tubular sensor moving structure includes a second guide portion configured to coaxially mate with the first guide portion, a second axial connecting portion for operatively engaging the first axial connecting portion to effectively interconnect the tubular sensor moving structure with the tubular sensor supporting structure to transmit an insertion force therebetween during insertion of the torque sensor on the axle, a second tube portion having a second internal bore to receive a portion of the axle attachment structure therein, and a second sensor abutment surface arranged to abut against the torque sensor when the torque sensor insertion tool is assembled in a torque sensor insertion arrangement.

In accordance with a second aspect of the invention, a torque sensor deinsertion tool for removing a torque sensor disposed on an axle. The torque sensor deinsertion tool of this aspect of the invention basically comprises an outer member, an inner member and a nut member. The outer member includes a first end, a second end with a bottom bracket engagement portion and an internal tubular surface with an internal thread. The inner member includes a first end and a second end with an external thread. The inner member is disposed within the outer member when the torque sensor deinsertion tool is assembled in a torque sensor deinsertion arrangement. The nut member includes an external thread threadedly engaged with the internal thread of the outer member, with the nut member contacting the first end of the inner member when in the torque sensor deinsertion arrangement.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a portion of this original disclosure:

FIG. 1 is a side elevational view of a bicycle equipped with a torque sensor that is installed with a torque sensor insertion tool and removed with a torque sensor deinsertion tool in accordance with the present invention;

FIG. 2 is a cross-sectional view of a crank assembly equipped with the torque sensor that was installed removed with the torque sensor insertion tool in accordance with the present invention;

FIG. 3 is an enlarged cross-sectional view of the crank axle assembly illustrated in FIG. 2 with the torque sensor installed thereon;

FIG. 4 is a perspective view of a crank axle with the torsion-detecting sleeve member (torque sensor unit) fastened thereon via a press-fit using a torque sensor insertion tool in accordance with the present invention;

FIG. 5 is an exploded perspective view of the torsion-detecting sleeve member (torque sensor unit) and FIG. 5 is an exploded perspective view of the torsion-detecting sleeve member (torque sensor unit) and the torque sensor insertion tool in accordance with a first embodiment;

FIG. 6 is a rear side elevational view of the crank axle disposed in the hanger part of the frame with the axle attachment structure of the torque sensor insertion tool attached to the crank axle;

FIG. 7 is a longitudinal cross sectional view of the crank axle disposed in the hanger part of the frame with the axle attachment structure of the torque sensor insertion tool attached to the crank axle;

FIG. 8 is a rear side elevational view of the crank axle disposed in the hanger part of the frame with the axle attachment structure of the torque sensor insertion tool attached to the crank axle and the torsion-detecting sleeve member (torque sensor unit) positioned on the sensor supporting portion of the axle attachment structure;

FIG. 9 is a longitudinal cross sectional view of the crank axle disposed in the hanger part of the frame with the axle attachment structure of the torque sensor insertion tool attached to the crank axle and the torsion-detecting sleeve member (torque sensor unit) positioned on the sensor supporting portion of the axle attachment structure;

FIG. 10 is a rear side elevational view of the crank axle disposed in the hanger part of the frame with the axle attachment structure of the torque sensor insertion tool attached to the crank axle and the torsion-detecting sleeve member (torque sensor unit) positioned on the sensor supporting portion of the axle attachment structure with part of the tubular sensor supporting structure installed over the torsion-detecting sleeve member (torque sensor unit);

FIG. 11 is a longitudinal cross sectional view of the crank axle disposed in the hanger part of the frame with the axle attachment structure of the torque sensor insertion tool attached to the crank axle and the torsion-detecting sleeve member (torque sensor unit) positioned on the sensor supporting portion of the axle attachment structure with part of the tubular sensor supporting structure installed over the torsion-detecting sleeve member (torque sensor unit);

FIG. 12 is a rear side elevational view of the crank axle disposed in the hanger part of the frame with the axle attachment structure of the torque sensor insertion tool attached to the crank axle and the torsion-detecting sleeve member (torque sensor unit) positioned between the sensor supporting portion of the axle attachment structure and the tube portion of the tubular sensor supporting structure and part of the tubular sensor moving structure installed;

FIG. 13 is a longitudinal cross sectional view of the crank axle disposed in the hanger part of the frame with the axle attachment structure of the torque sensor insertion tool attached to the crank axle and the torsion-detecting sleeve member (torque sensor unit) positioned between the sensor supporting portion of the axle attachment structure and the tube portion of the tubular sensor supporting structure and part of the tubular sensor moving structure installed;

FIG. 14 is a rear side elevational view of the crank axle disposed in the hanger part of the frame with the torque sensor insertion tool fully assembled and attached to the crank axle, but prior to final adjustment of the torque sensor insertion tool;

FIG. 15 is a longitudinal cross sectional view of the crank axle disposed in the hanger part of the frame with the torque sensor insertion tool fully assembled and attached to the crank axle, but prior to final adjustment of the torque sensor insertion tool;

FIG. 16 is a rear side elevational view of the crank axle disposed in the hanger part of the frame with the torque sensor insertion tool fully assembled and attached to the crank axle so as to be ready to install the torsion-detecting sleeve member (torque sensor unit);

FIG. 17 is a longitudinal cross sectional view of the crank axle disposed in the hanger part of the frame with the torque sensor insertion tool fully assembled and attached to the crank axle so as to be ready to install the torsion-detecting sleeve member (torque sensor unit);

FIG. 18 is a rear side elevational view of the crank axle disposed in the hanger part of the frame with the torsion-detecting sleeve member (torque sensor unit) installed onto the crank axle by the torque sensor insertion tool;

FIG. 19 is a longitudinal cross sectional view of the crank axle disposed in the hanger part of the frame with the torsion-detecting sleeve member (torque sensor unit) installed onto the crank axle by the torque sensor insertion tool;

FIG. 20 is a perspective view of the axle attachment structure of the torque sensor insertion tool in accordance with the first embodiment;

FIG. 21 is a side elevational view of the axle attachment structure of the torque sensor insertion tool illustrated in FIG. 20;

FIG. 22 is an end elevational view of the axle attachment structure of the torque sensor insertion tool illustrated in FIGS. 20 and 21;

FIG. 23 is a perspective view of the tube member of the tubular sensor supporting structure for the torque sensor insertion tool in accordance with the first embodiment;

FIG. 24 is an end elevational view of the tube member of the tubular sensor supporting structure for the torque sensor insertion tool illustrated in FIG. 23;

FIG. 25 is a perspective view of the adjustment nut of the tubular sensor supporting structure for the torque sensor insertion tool in accordance with the first embodiment;

FIG. 26 is an end elevational view of the adjustment nut of the tubular sensor supporting structure for the torque sensor insertion tool illustrated in FIG. 25;

FIG. 27 is a perspective view of the tube member of the tubular sensor moving structure for the torque sensor insertion tool in accordance with the first embodiment;

FIG. 28 is an end elevational view of the tube member of the tubular sensor moving structure for the torque sensor insertion tool illustrated in FIG. 27;

FIG. 29 is a perspective view of the washer of the tubular sensor moving structure for the torque sensor insertion tool in accordance with the first embodiment;

FIG. 30 is an end elevational view of the washer of the tubular sensor moving structure for the torque sensor insertion tool illustrated in FIG. 29;

FIG. 31 is a perspective view of the insertion nut of the tubular sensor moving structure for the torque sensor insertion tool in accordance with the first embodiment;

FIG. 32 is an end elevational view of the insertion nut of the tubular sensor moving structure for the torque sensor insertion tool illustrated in FIG. 31;

FIG. 33 is an exploded perspective view of the torsion-detecting sleeve member (torque sensor unit) and a torque sensor insertion tool in accordance with a second embodiment;

FIG. 34 is a rear side elevational view of the crank axle disposed in the hanger part of the frame with the torque sensor insertion tool fully assembled and attached to the crank axle in accordance with the second embodiment so as to be ready to install the torsion-detecting sleeve member (torque sensor unit);

FIG. 35 is a longitudinal cross sectional view of the crank axle disposed in the hanger part of the frame with the torque sensor insertion tool fully assembled and attached to the crank axle in accordance with the second embodiment so as to be ready to install the torsion-detecting sleeve member (torque sensor unit);

FIG. 36 is a rear side elevational view of the crank axle disposed in the hanger part of the frame with the torsion-detecting sleeve member (torque sensor unit) installed onto the crank axle by the torque sensor insertion tool of the second embodiment;

FIG. 37 is a longitudinal cross sectional view of the crank axle disposed in the hanger part of the frame with the torsion-detecting sleeve member (torque sensor unit) installed onto the crank axle by the torque sensor insertion tool of the second embodiment;

FIG. 38 is an exploded perspective view of a torque sensor deinsertion tool in accordance with one preferred embodiment;

FIG. 39 is a longitudinal cross sectional view of the crank axle disposed in the hanger part of the frame with the torsion-detecting sleeve member (torque sensor unit) installed onto the crank axle and the torque sensor deinsertion tool attached to the crank axle;

FIG. 40 is a longitudinal cross sectional view of the crank axle disposed in the hanger part of the frame with the torsion-detecting sleeve member (torque sensor unit) removed from the crank axle by the torque sensor deinsertion tool;

FIG. 41 is a perspective view of the outer member of the torque sensor deinsertion tool illustrated in FIGS. 38 to 40;

FIG. 42 is a side elevational view of the outer member illustrated in FIG. 41 for the torque sensor deinsertion tool illustrated in FIGS. 38 to 40;

FIG. 43 is an end elevational view of the outer member illustrated in FIGS. 41 and 42 for the torque sensor deinsertion tool illustrated in FIGS. 38 to 40;

FIG. 44 is a perspective view of the inner member of the torque sensor deinsertion tool illustrated in FIGS. 38 to 40;

FIG. 45 is a side elevational view of the inner member illustrated in FIG. 44 for the torque sensor deinsertion tool illustrated in FIGS. 38 to 40;

FIG. 46 is an end elevational view of the inner member illustrated in FIGS. 44 and 45 for the torque sensor deinsertion tool illustrated in FIGS. 38 to 40;

FIG. 47 is a perspective view of the nut member of the torque sensor deinsertion tool illustrated in FIGS. 38 to 40;

FIG. 48 is an end elevational view of the nut member illustrated in FIG. 47 for the torque sensor deinsertion tool illustrated in FIGS. 38 to 40; and

FIG. 49 is a cross sectional view of the nut member illustrated in FIGS. 47 and 48 for the torque sensor deinsertion tool illustrated in FIGS. 38 to 40.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

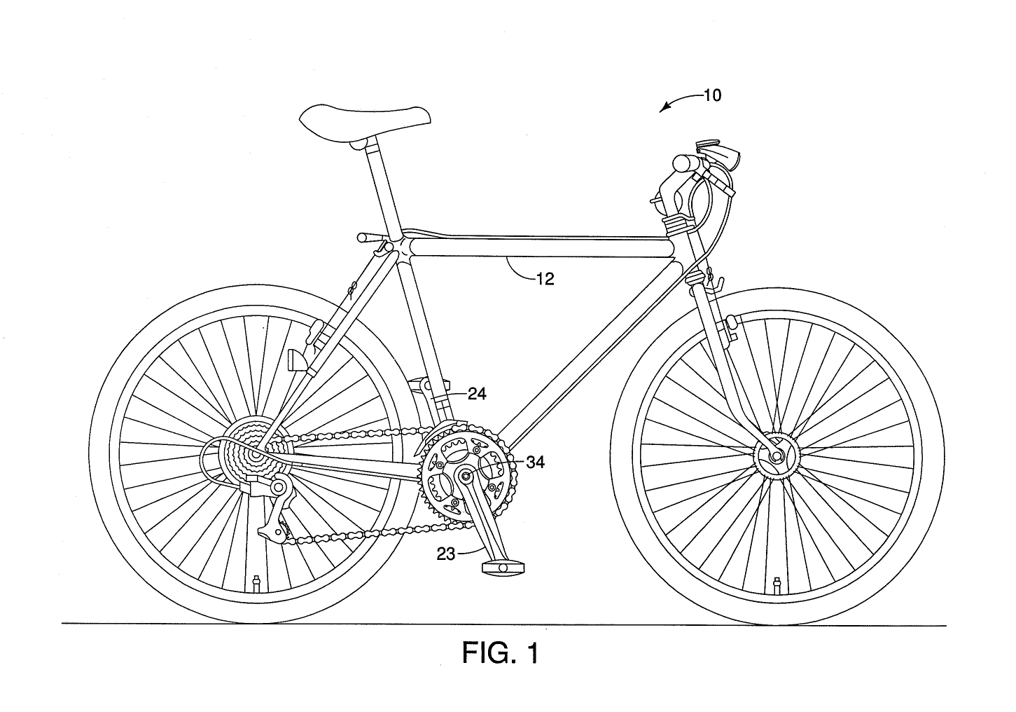

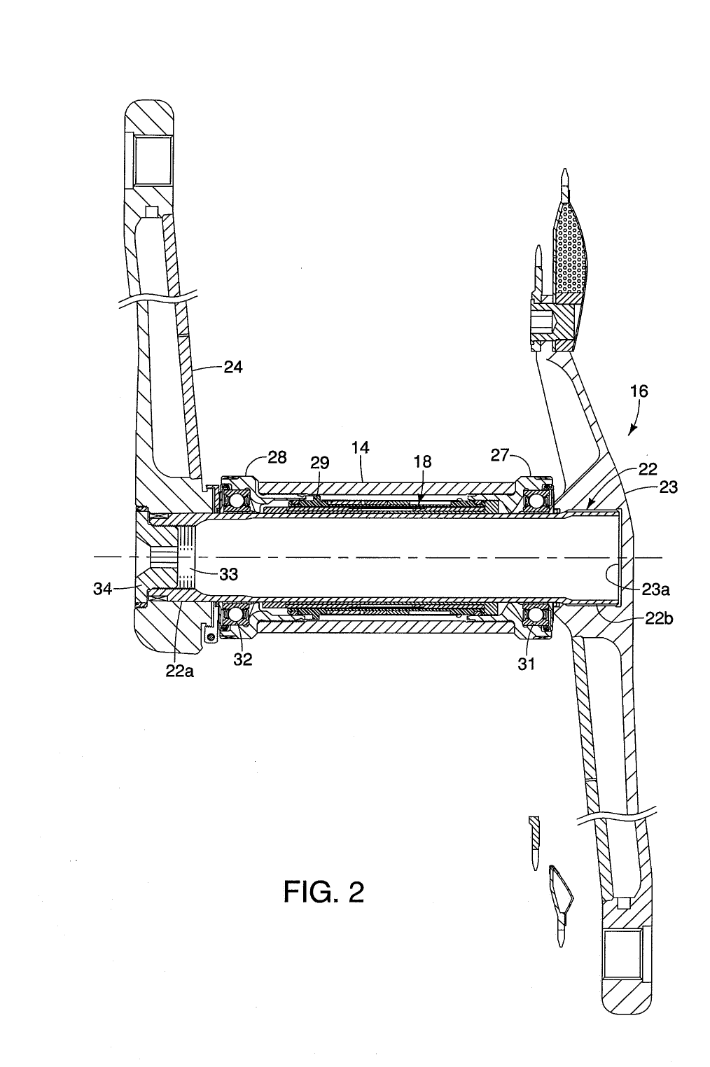

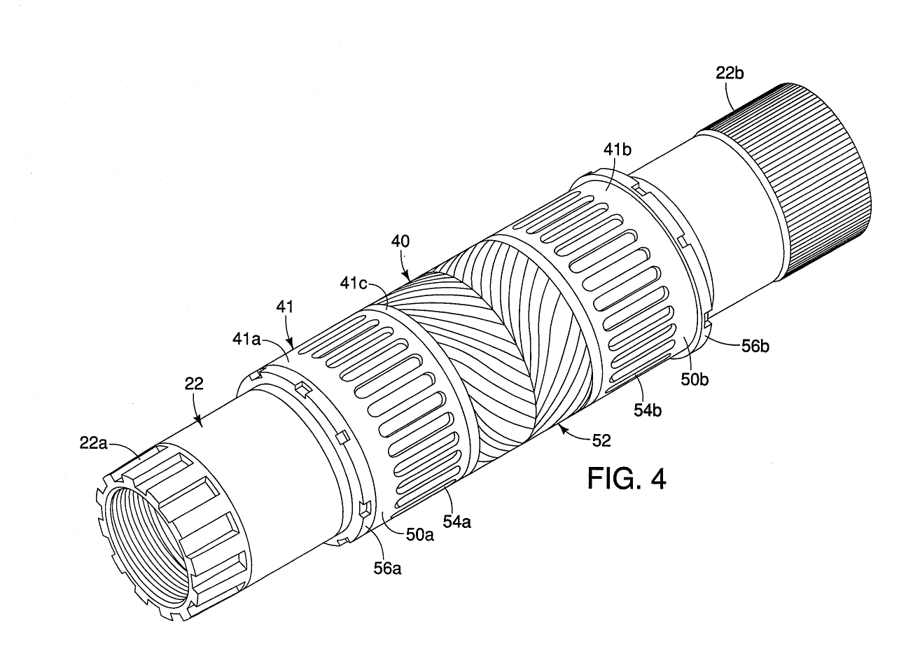

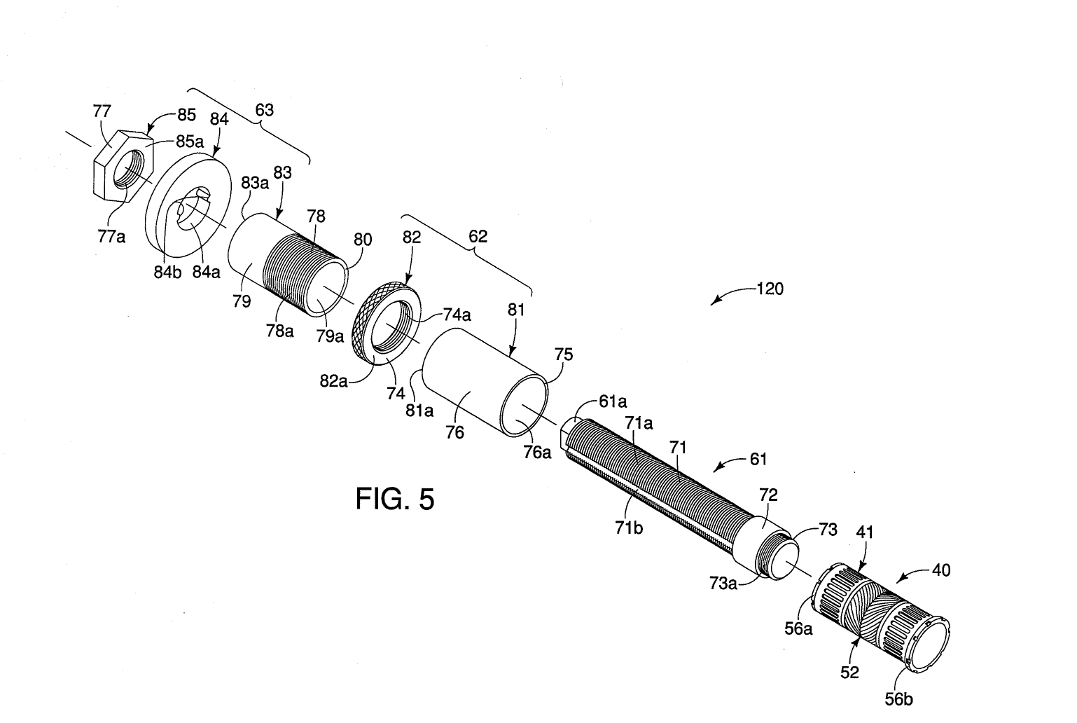

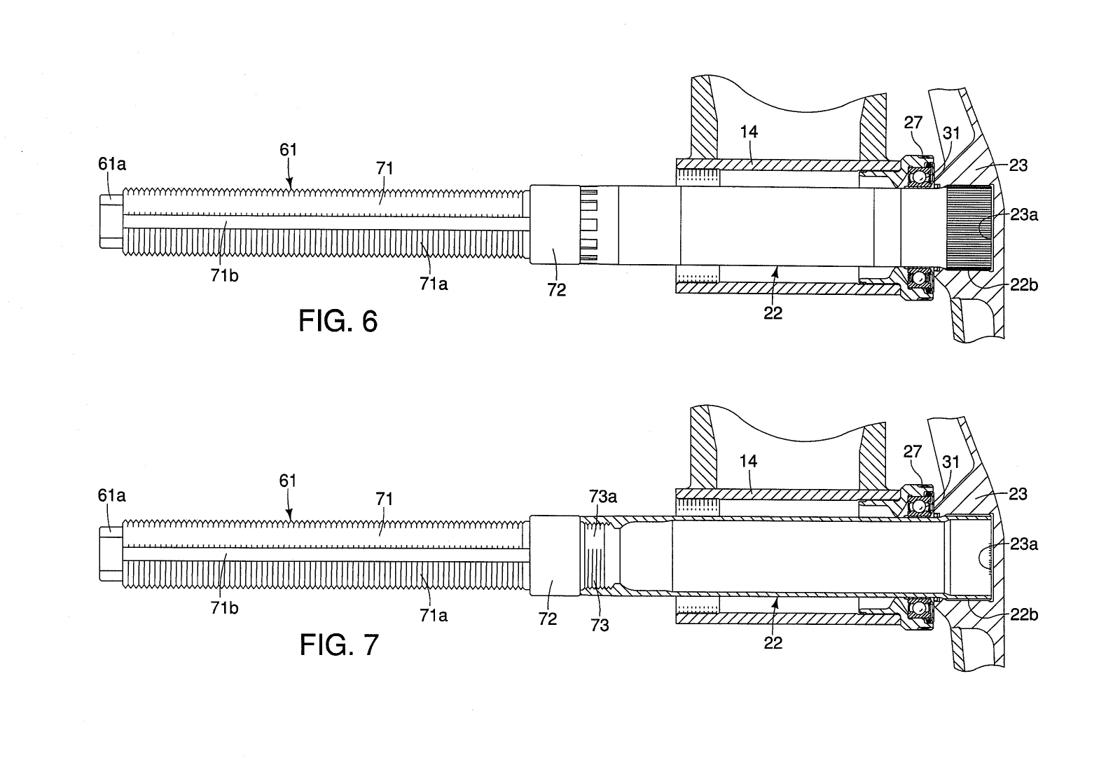

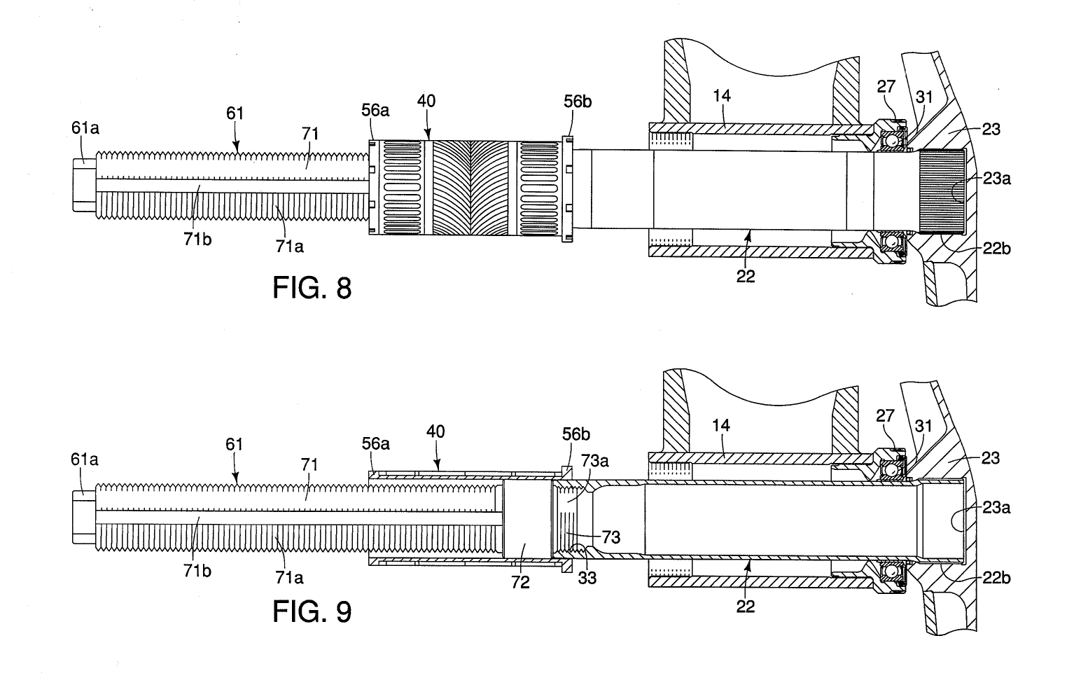

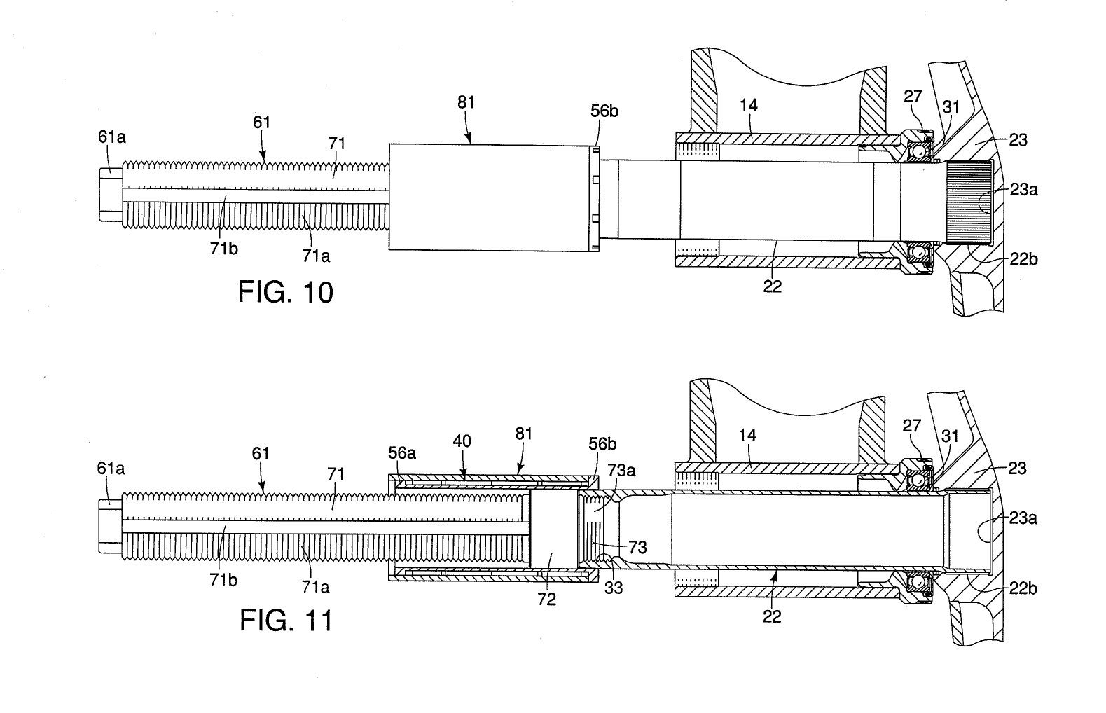

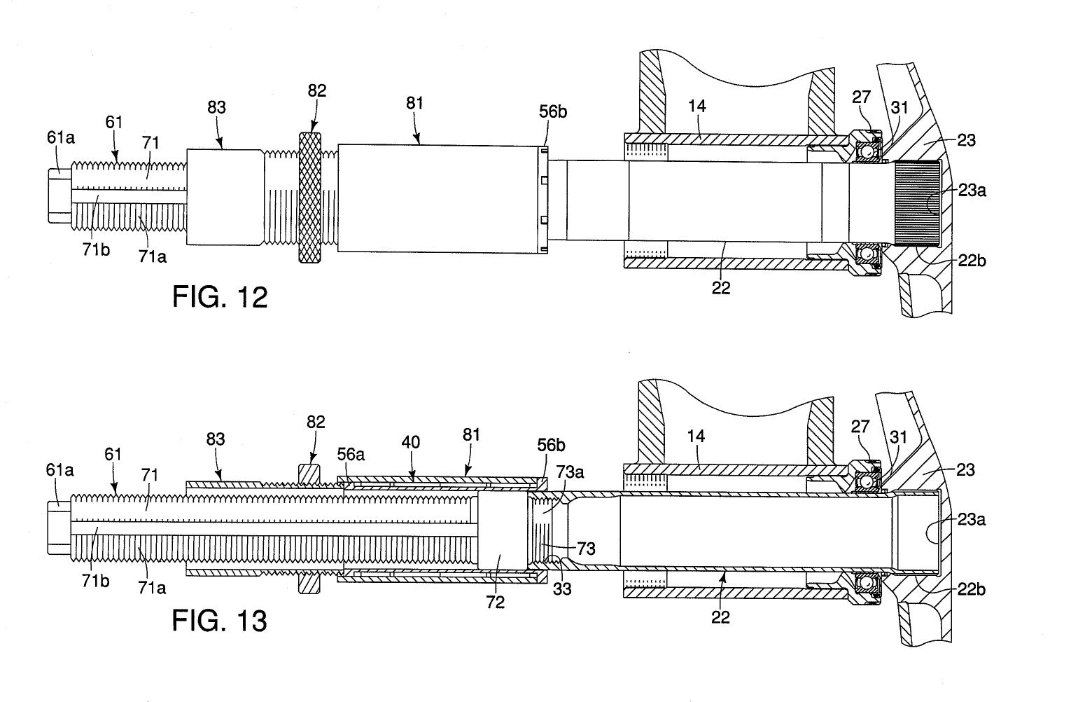

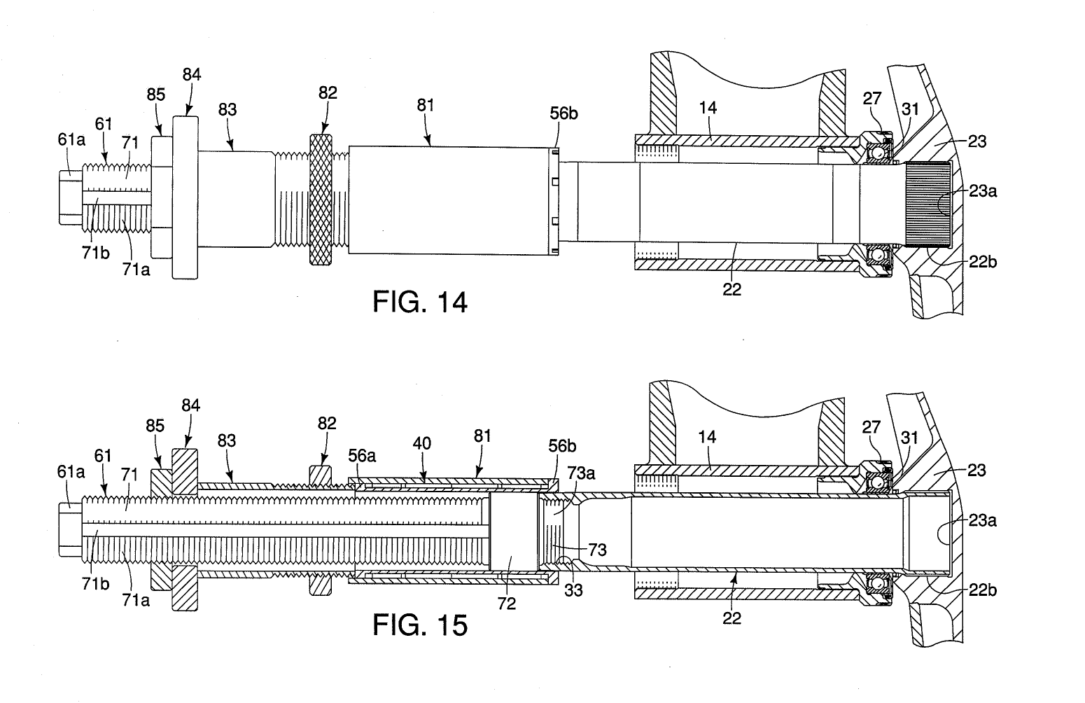

Referring initially to FIG. 1, a bicycle 10 is illustrated in accordance with a first embodiment of the present invention. In FIG. 1, the bicycle 10 is a mountain bike that is particularly suitable for off-road use. The bicycle 10 includes a frame 12 having a diamond-shaped frame body with a hanger part 14 (FIG. 2) that supports a front crank assembly 16. As shown in FIGS. 2 to 5, the front crank assembly 16 has a torque sensor 18. A part of the torque sensor 18 is installed using a torque sensor insertion tool 20 as shown in FIGS. 5 to 19 (discussed below).

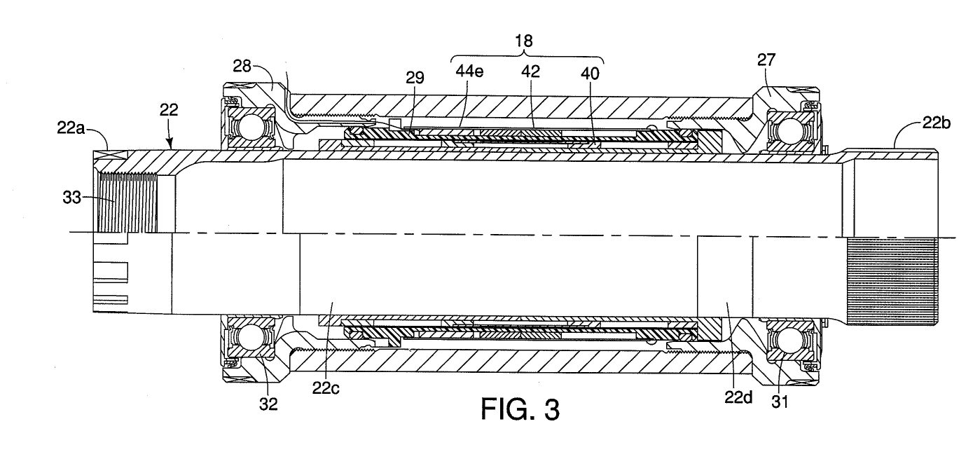

As shown in FIG. 2, the front crank assembly 16 has a crank axle 22 (an example of a torque transmission shaft or axle), a right gear crank 23 detachably fixed to the right end of the crank axle 22, a left crank 24 detachably fixed to the left end of the crank axle 22, a first threaded adapter 27, a second threaded adapter 28 and a cylindrical mounting member 29. The torque sensor 18 is operatively installed between the crank axle 22 and the cylindrical mounting member 29. The first threaded adapter 25 is a cylindrical member that is threaded in from the right end of the hanger part 14. The second threaded adapter 26 is a cylindrical member that is threaded in from the left end. The crank axle 22 is rotatably supported on the first threaded adapter 25. The torque sensor 18 (e.g., a torque-detecting device) is configured and arranged for detecting torque that acts on the crank axle 22, as shown in FIG. 3. Also the cylindrical mounting member 29 made of a synthetic resin, for example, is mounted between the first and second threaded adapters 25 and 26.

The crank axle 22 is a hollow cylindrical member that is rotatably mounted on the hanger part 14 via the bearings 31 and 32 and the first and second threaded adapters 25 and 26. The crank axle 22 has a crank mounting part 22a with a tapered surface formed in the external peripheral surface at the left end of the crank axle 22. The left crank 24 is integrally and rotatably mounted on the crank mounting part 22a. The right end of the crank axle 22 has a large-diameter serration part 22b that is press-fitted into the mounting hole 23a of the gear crank 23 to allow the gear crank 23 to be fastened by crimping. Thus, the right end of the crank axle 22 is fixedly and rigidly coupled to the gear crank 23 so that that they rotate together as an integrated unit.

As seen in FIGS. 3 and 4, the external peripheral surface of the crank axle 22 is provided with two press-fitting surfaces 22c and 22d that form a slight stepped arrangement. The press-fitting surfaces 22c and 22d have outer diameter with the outer diameter of the press-fitting surface 22d increasing slightly relative to the outer diameter of the press-fitting surface 22c. Furthermore, a thread hole 33 is formed in the left end surface. The thread hole 33 threadedly receives the fastening bolt 34.

The torque sensor 18 comprises a torsion-detecting sleeve member 40, a torsion signal detector 42 and a rotational torque output unit 44, as shown in FIGS. 3 and 4. The torsion-detecting sleeve member 40 is attached via a press-fit to the crank axle 22 at two axially spaced apart locations to detect torsion occurring in the crank axle 22. The torsion signal detector 42 and the rotational torque output unit 44 are mounted on the mounting member 29. Since the precise structure of the torque sensor 18 is not essential, to understanding the invention, the torque sensor 18 will not be discussed or illustrated in detail herein. The torsion-detecting sleeve member 40 constitutes a torsion sensor unit that is installed on the crank axle 22 via a press-fit as discussed below.

The torsion-detecting sleeve member 40 has a cylindrical sleeve main body 41 with first and second cylindrical members 41a and 41b made of, e.g., a comparatively rigid metal such as SK5 or any other suitable carbon tool steel, and a third cylindrical member 41c made of, e.g., SUS 304 or any other suitable nonmagnetic metal and disposed between the first and second cylindrical members 41a and 41b, as shown in FIG. 3. The sleeve member 40 also includes a first torque-acting part 50a, a second torque-acting part 50b, a torsion signal generator 52, a first torsion converter part 54a, a second torsion converter part 54b, a first press-fitted member 56a and a second press-fitted member 56b. The first and second cylindrical torque-acting parts 50a and 50b are disposed at two axially spaced apart locations. The torsion signal generator 52 is provided to at least part of the external peripheral surface between the first and second cylindrical torque-acting parts 50a and 50b. The torsion converter parts 54a and 54b are provided between the first and second cylindrical torque-acting parts 50a and 50b and the torsion signal generator 52. The torsion signal generator 52 is configured and arranged for converting the torsion transmitted from the first and second cylindrical torque-acting parts 50a and 50b to the torsion signal generator 52.

The first and second cylindrical torque-acting parts 50a and 50b and the torsion converter parts 54a and 54b are disposed respectively on the first and second cylindrical members 41a and 41b. The torsion signal generator 52 is disposed on the third cylindrical member 41c. The first and second cylindrical torque-acting parts 50a and 50b are provided separately to the ends of the sleeve member 40, i.e., to two locations at the axially outward ends of the first and second cylindrical members 41a and 41b. The first and second cylindrical torque-acting parts 50a and 50b are fastened separately to first and second press-fitted members 56a and 56b, which are fastened to the crank axle 22 by being press fitted from both end sides. In the torque sensor 18 configured in this manner, when the crank axle 22 twists, torsion is created between the first and second cylindrical torque-acting parts 50a and 50b via the first and second press-fitted members 56a and 56b.

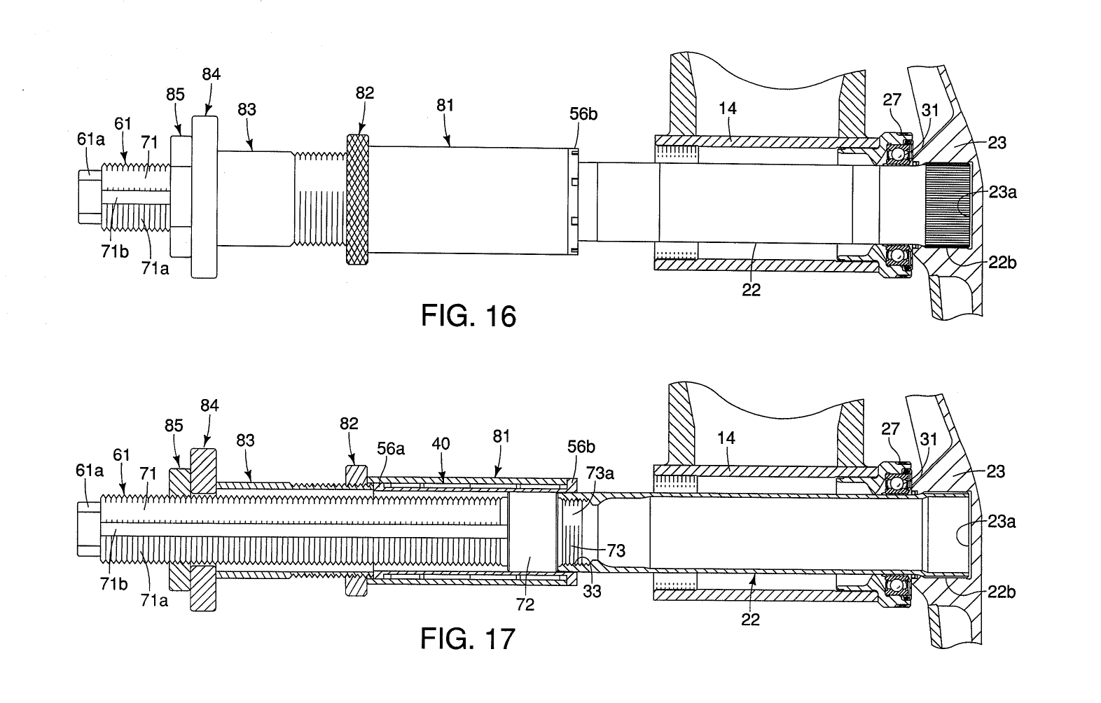

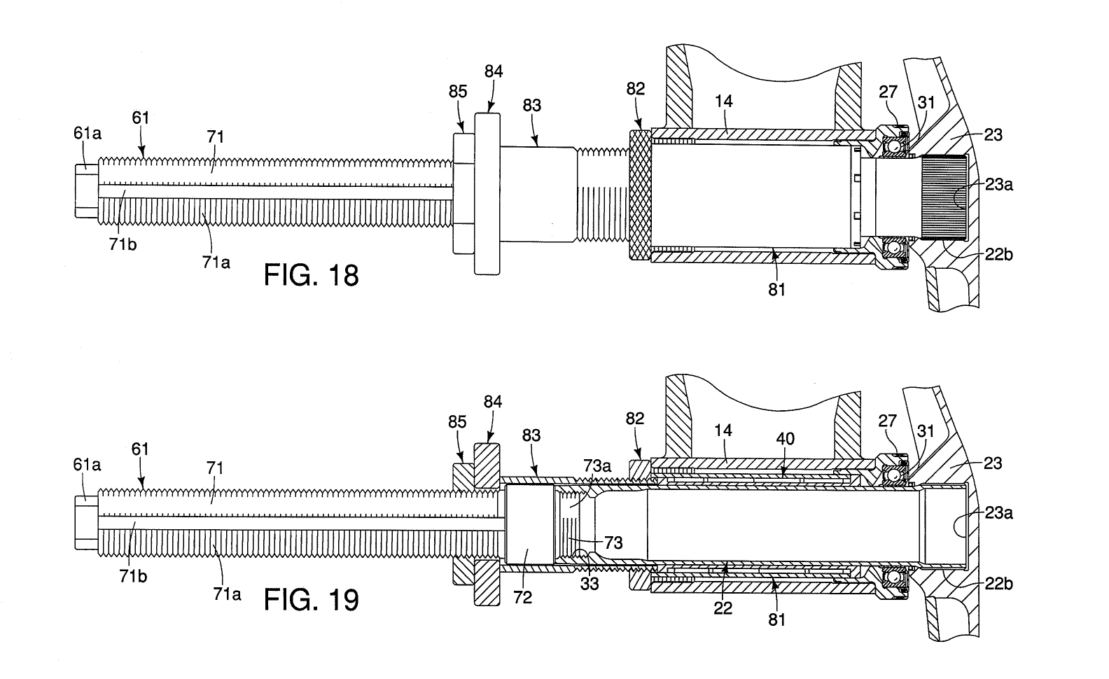

As seen in FIGS. 5 to 19, the torque sensor insertion tool 20 basically includes an axle attachment structure 61, a tubular sensor supporting structure 62 and a tubular sensor moving structure 63. The torque sensor insertion tool 20 is configured and arranged for installing the torsion-detecting sleeve member 40 (the torsion sensor unit) onto the crank axle 22. Basically, the axle attachment structure 61 is an axle extension member that is fixedly attached to the left end of the crank axle 22. The axle attachment structure 61 is configured and arranged to support the inner periphery of the torsion-detecting sleeve member 40 (the torsion sensor unit). The tubular sensor supporting structure 62 is configured and arranged to support the outer periphery of the torsion-detecting sleeve member 40 (the torsion sensor unit). The tubular sensor moving structure 63 is configured and arranged to move the torsion-detecting sleeve member 40 (the torsion sensor unit) from a position disposed between the axle attachment structure 61 and the tubular sensor supporting structure 62 (FIGS. 16 and 17) to a position disposed on the crank axle 22 (FIGS. 18 and 19).

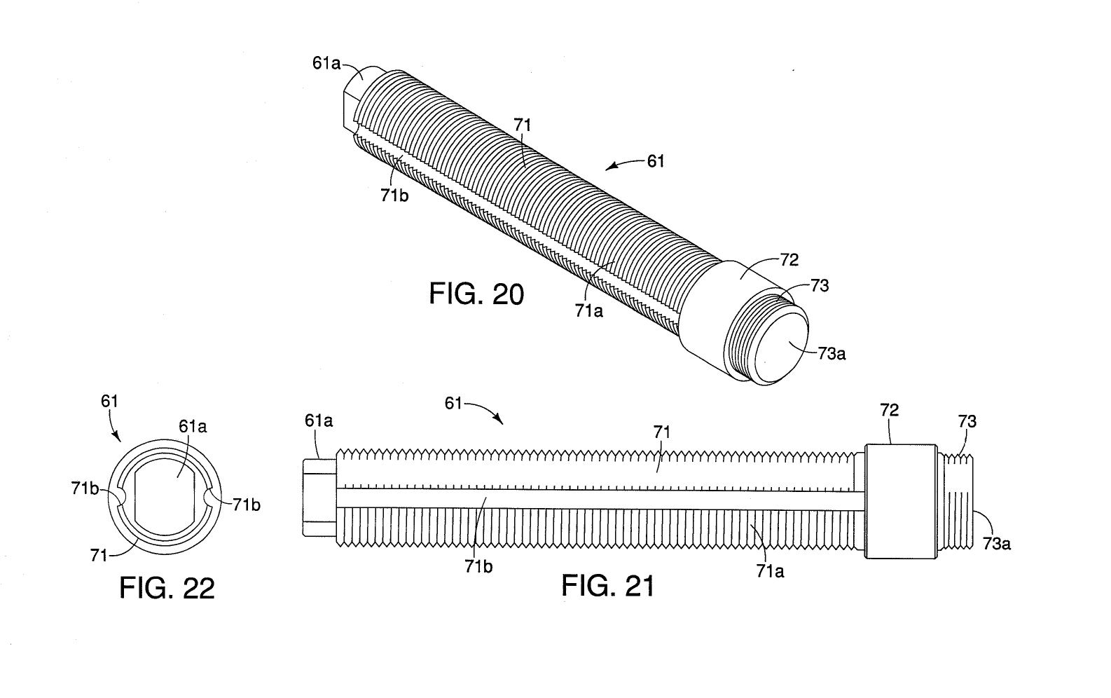

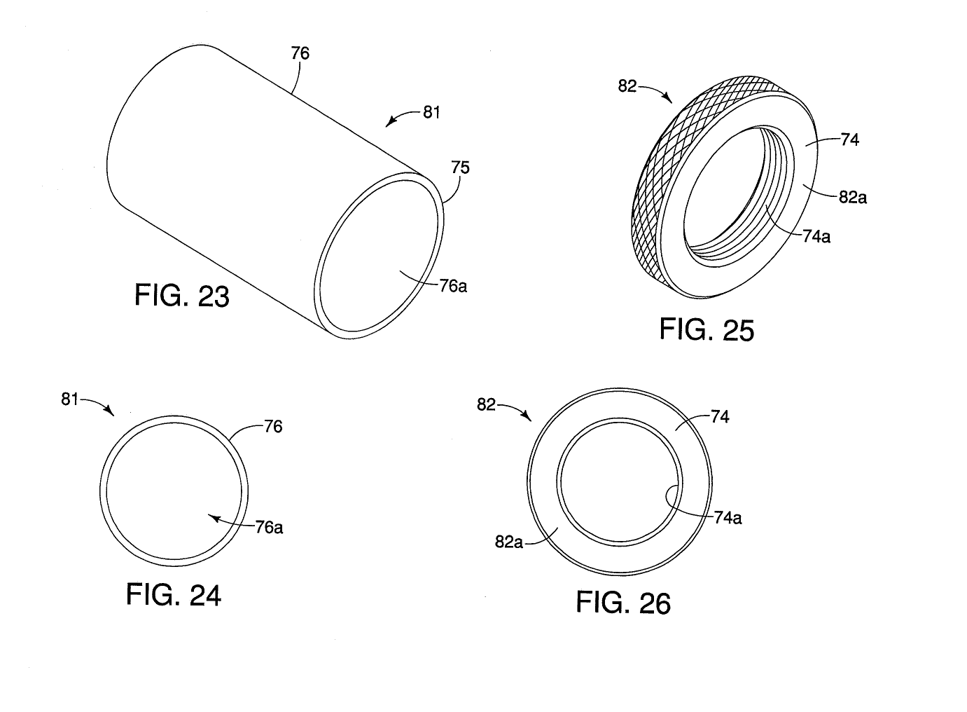

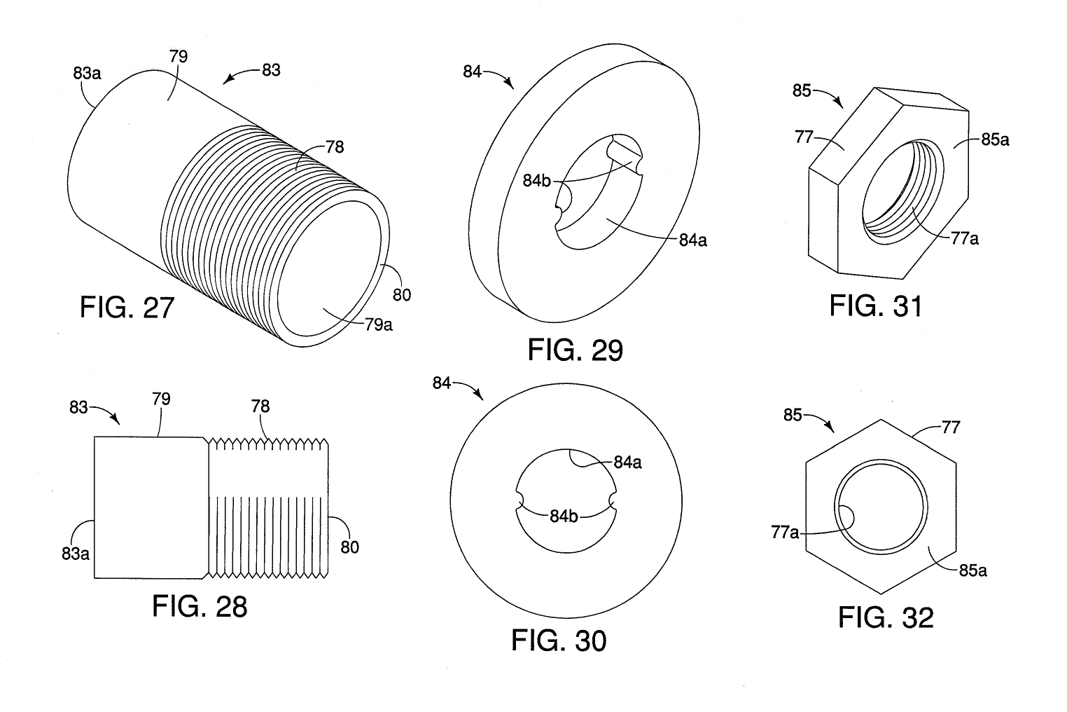

As seen in FIGS. 20 to 22, in this illustrated embodiment, the axle attachment structure 61 includes a first guide portion 71, a sensor supporting portion 72 and an axle attachment portion 73. In this illustrated embodiment, the first guide portion 71, the sensor supporting portion 72 and the axle attachment portion 73 are integrally formed as a one-piece, unitary member from a hard, rigid material. The axle attachment structure 61 is fixed to the crank axle 22 so as to form an extension of the crank axle 22.

The first guide portion 71 cooperates with the tubular sensor moving structure 63, as explained below, for linearly guiding the torsion-detecting sleeve member 40. In particular, the first guide portion 71 is an externally threaded portion with an external thread 71a and a pair of longitudinal grooves 71b. The sensor supporting portion 72 is a cylindrical portion with an outer diameter that is dimensioned to be substantially identical to the inner diameter of the torsion-detecting sleeve member 40. Thus, the sensor supporting portion 72 is configured to support an inner surface of the torsion-detecting sleeve member 40. Moreover, preferably, the outer diameter is substantially identical to the outer diameter of the external peripheral surface of the crank mounting part 22a such that the torsion-detecting sleeve member 40 can be easily inserted onto the crank mounting part 22a of the crank axle 22. The axle attachment portion 73 is configured to be fixedly coupled to the crank mounting part 22a of the crank axle 22. In this illustrated embodiment, the axle attachment portion 73 is an externally threaded portion with an external thread 73a that threadedly engages the thread hole 33 of the crank axle 22.

As seen in FIGS. 20 to 22, in this illustrated embodiment, the tubular sensor supporting structure 62 includes a first axial connecting portion 74, a first sensor abutment surface 75 and a first tube portion 76, with the first sensor abutment surface 75 and the first tube portion 76 being formed by an outer tubular member 81 and the first axial connecting portion 74 being an adjustable nut 82 that is separate and distinct piece from the outer tubular member 81. The adjustable nut 82 has an axial facing end surface 82a that directly abuts against an axial facing end surface 81a of the outer tubular member 81. Thus, the first axial connecting portion 74 is a separate and distinct piece from the first tube portion 76, with the first axial connecting portion 74 having the axial facing end surface 82a acting as a force transmitting surface for contacting the axial facing end surface 81a (force transmitting surface) of the outer tubular member 81a of the first tube portion when the torque sensor insertion tool 20 is assembled in a torque sensor insertion arrangement.

The first axial connecting portion 74 is an internally threaded portion with an internal thread 74a. As explained below, the internal thread 74a of the first axial connecting portion 74 cooperates with the tubular sensor moving structure 63 such that the axial facing end surface 82a of the adjustable nut 82 directly abuts (contacts) against an axial facing end surface 81a of the outer tubular member 81. Thus, the adjustable nut 82 transmits an axially directed force from the tubular sensor moving structure 63 through the outer tubular member 81 to the second press-fitted member 56b which forms an end flange of the torsion-detecting sleeve member 40. In other words, the first sensor abutment surface 75 faces in a first axial direction for contacting the second press-fitted member 56b (e.g., a first abutment portion) of the torsion-detecting sleeve member 40. The first sensor abutment surface 75 directly abuts (contacts) against the second press-fitted member 56b (end flange) of the torsion-detecting sleeve member 40 to apply a pressing force to the torsion-detecting sleeve member 40 during installation of the torsion-detecting sleeve member 40 onto the crank axle 22.

As explained below, the internal thread 74a of the first axial connecting portion 74 also cooperates with the tubular sensor moving structure 63 such that the tubular sensor moving structure 63 contacts the first press-fitted member 56a which forms an end abutment of the torsion-detecting sleeve member 40. Thus, the tubular sensor moving structure 63 contacts the first press-fitted member 56a to support to the first press-fitted member 56a (end abutment) of the torsion-detecting sleeve member 40 during installation of the torsion-detecting sleeve member 40 onto the crank axle 22. Preferably, the pressing force from the tubular sensor moving structure 63 on the first press-fitted member 56a of the torsion-detecting sleeve member 40 is nearly zero during installation of the torsion-detecting sleeve member 40 onto the crank axle 22.

The first tube portion 76 has a first internal bore 76a with an inner width or diameter that is dimensioned relative to an outer width of the sensor supporting portion 72 of the axle attachment structure 61 to form a predetermined annular sensor receiving space therebetween for receiving the torsion-detecting sleeve member 40 when the axle attachment structure 61 is located in the first internal bore 76a.

As seen in FIGS. 20 to 22, in this illustrated embodiment, the tubular sensor moving structure 63 includes a second guide portion 77, a second axial connecting portion 78, a second tube portion 79 and a second sensor abutment surface 80. In this illustrated embodiment, the second axial connecting portion 78, the second tube portion 79 and the second sensor abutment surface 80 are formed as an inner tubular member 83 that is a one-piece, unitary member with a force transmitting surface 83a at one end and the second sensor abutment surface 80 at the other end. The tubular sensor moving structure 63 further includes a washer 84 disposed between the force transmitting surfaces of the second guide portion 77 and the second tube portion 79, with the washer 84 having a non-rotatable connection with the axle attachment structure 61. The second guide portion 77 is formed as part of an insertion nut 85 that is a separate and distinct piece from the inner tubular member 83 and the washer 84. In other words, the second guide portion 77 is a separate and distinct piece from the second tube portion 79, with the second guide portion 77 having the force transmitting surface 85a facing axially towards a force transmitting surface 83a of the second tube portion 77 when the torque sensor insertion tool 20 is assembled in a torque sensor insertion arrangement. In the illustrated embodiment, the pressing force from the insertion nut 85 to the inner tubular member 83 is transmitted through the washer 84. The washer 84 has a non-threaded hole 84a for receiving the first guide portion 71 therethrough and a pair of projections 84b for engaging the grooves 71b of the first guide portion 71. The projections 84b engage the grooves 71b of the first guide portion 71 to prevent the washer 84 from turning when the insertion nut 85 is rotated. Thus, the turning torque of the insertion nut 85 is not transmitted to the inner tubular member 83.

The second guide portion 77 is configured to coaxially mate with the first guide portion 71. In particular, the second guide portion 77 includes an internal thread 77a that is threadedly engaged with the external thread 71a of the first guide portion 71. Thus, the threads 71a and 77a are mating threads. Preferably, the internal thread 77a of the insertion nut 85 is designed with a screw torque of 12 kgf/cm such that the threads 71a and 77a are configured with to cooperate with each other to apply a propulsive force of 42 kgf/cm to the torsion-detecting sleeve member 40 during installation of the torsion-detecting sleeve member 40 onto the crank axle 22.

The second axial connecting portion 78 is configured and arranged for operatively engaging the first axial connecting portion 74 to effectively interconnect the tubular sensor moving structure 63 with the tubular sensor supporting structure 62 to transmit an insertion or pressing force therebetween during insertion or installation of the torsion-detecting sleeve member 40 onto the crank axle 22.

The second tube portion 79 has a second internal bore 79a to receive a portion of the first guide portion 71 of the axle attachment structure 61 therein. The second internal bore 79a of the second tube portion 79 is dimensioned to be coaxially arranged about the first guide portion 71 with a predetermined amount of clearance therebetween.

The second sensor abutment surface 80 abuts (contacts) the first press-fitted member 56a to support to the first press-fitted member 56a (end abutment) of the torsion-detecting sleeve member 40 during installation of the torsion-detecting sleeve member 40 onto the crank axle 22. Preferably, the pressing force from the tubular sensor moving structure 63 on the first press-fitted member 56a of the torsion-detecting sleeve member 40 is nearly zero during installation of the torsion-detecting sleeve member 40 onto the crank axle 22.

In this embodiment, when the insertion nut 85 is screwed onto the axle attachment structure 61 by a tool (e.g. wrench), the second press-fitted member 56b (flange) of the torsion-detecting sleeve member 40 is pushed by the outer tubular member 81 via the inner tubular member 83. At the same time, the first press-fitted member 56a (end abutment) of the torsion-detecting sleeve member 40 is supported by the inner tubular member 83. Since a contact (support) point between the first press-fitted member 56a (end abutment) of the torsion-detecting sleeve member 40 and the inner tubular member 83 receives a counter pushing force from the first tube member, the first press-fitted member 56a (end abutment) of the torsion-detecting sleeve member 40 does not receives strong push power from the inner tubular member 83. But the first press-fitted member 56a (end abutment) of the torsion-detecting sleeve member 40 is supported by the inner tubular member 83. Thus, the torsion-detecting sleeve member 40 is inserted to the crank axle 22 without shape changing.

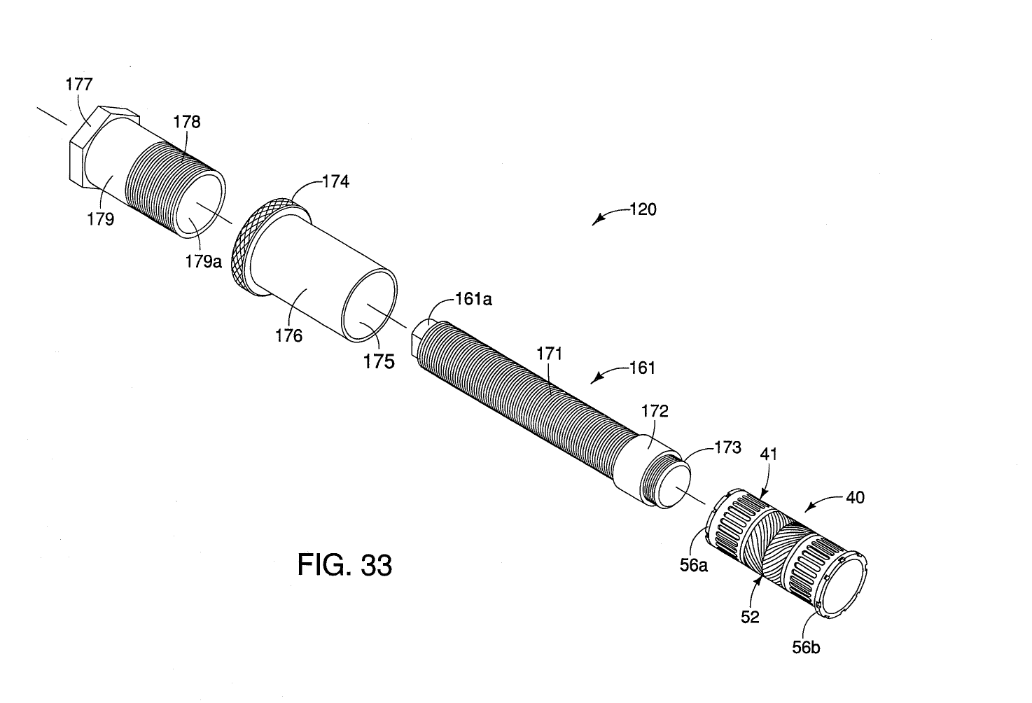

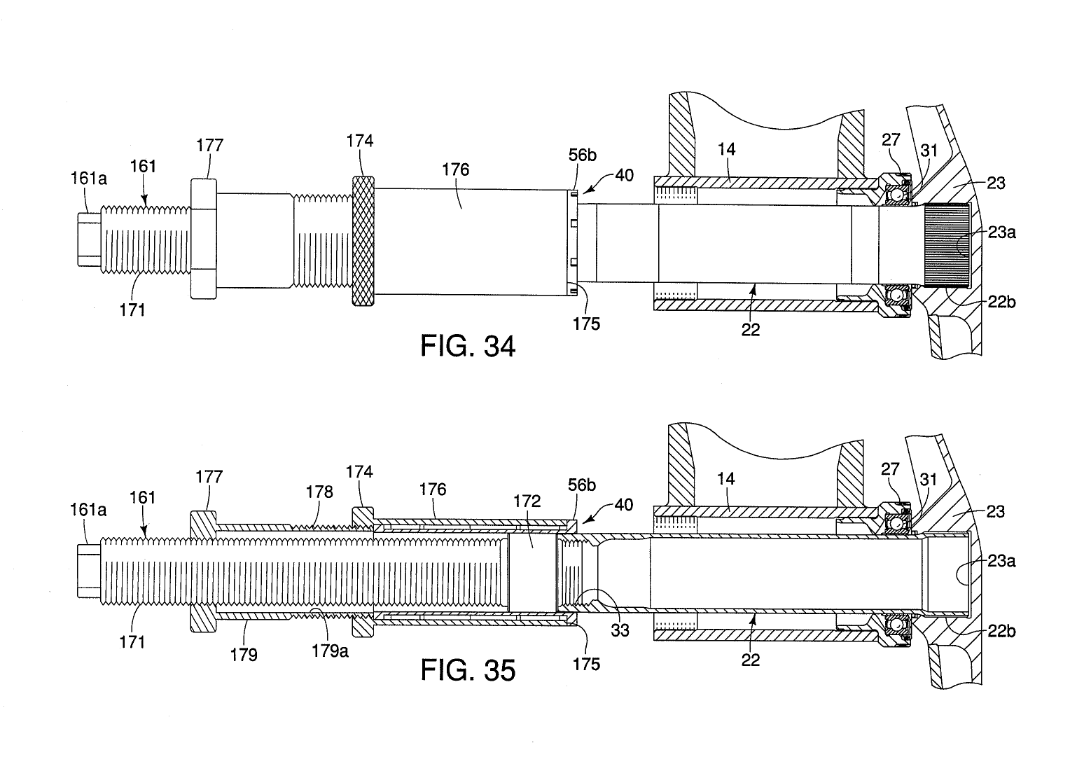

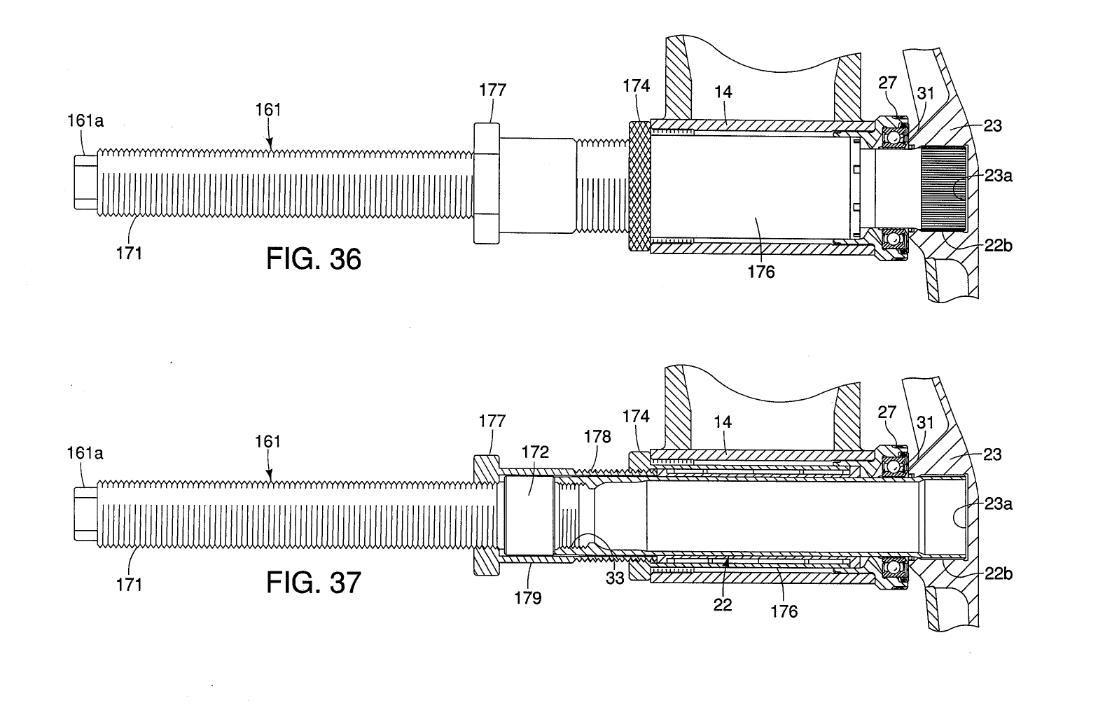

Referring now to FIGS. 33 to 37, a torque sensor insertion tool 120 is illustrated in accordance with a second embodiment. The torque sensor insertion tool 120 is functionally identical to the torque sensor insertion tool 120 to install the torsion-detecting sleeve member 40 onto the crank axle 22 in substantially the same way as the torque sensor insertion tool 20 of the first embodiment. However, in this second embodiment, certain parts have been integrated together relative to the first embodiment. In view of the similarity between the first and second embodiments, the descriptions of the parts of the second embodiment that are functionally identical to the parts of the first embodiment may be omitted for the sake of brevity.

In this illustrated embodiment, the torque sensor insertion tool 120 basically includes an axle attachment structure 161, a tubular sensor supporting structure 162 and a tubular sensor moving structure 163. The torque sensor insertion tool 120 is configured and arranged for installing the torsion-detecting sleeve member 40 (the torsion sensor unit) onto the crank axle 22. Basically, the axle attachment structure 161 is an axle extension member that is fixedly attached to the left end of the crank axle 22. The axle attachment structure 161 is configured and arranged to support the inner periphery of the torsion-detecting sleeve member 40 (the torsion sensor unit). The tubular sensor supporting structure 162 is configured and arranged to support the outer periphery of the torsion-detecting sleeve member 40 (the torsion sensor unit). The tubular sensor moving structure 163 is configured and arranged to move the torsion-detecting sleeve member 40 (the torsion sensor unit) from a position disposed between the axle attachment structure 161 and the tubular sensor supporting structure 62 (FIG. 35) to a position disposed on the crank axle 22 (FIG. 37).

The axle attachment structure 161 includes a first guide portion 171, a sensor supporting portion 172 and an axle attachment portion 173. In this illustrated embodiment, the first guide portion 171, the sensor supporting portion 172 and the axle attachment portion 173 are integrally formed as a one-piece, unitary member from a hard, rigid material. The axle attachment structure 161 is fixed to the crank axle 22 so as to form an extension of the crank axle 22.

In this illustrated embodiment, the tubular sensor supporting structure 162 includes a first axial connecting portion 174, a first sensor abutment surface 175 and a first tube portion 176. Here, the first axial connecting portion 174 is integrally formed with the first tube portion 176 as a one-piece, unitary member.

In this illustrated embodiment, the tubular sensor moving structure 163 includes a second guide portion 177, a second axial connecting portion 178, a second tube portion 179 and a second sensor abutment surface 180. Here, the second guide portion 177, the second axial connecting portion 178, the second tube portion 179 and the second sensor abutment surface 80 are all integrally formed as a one-piece, unitary member.

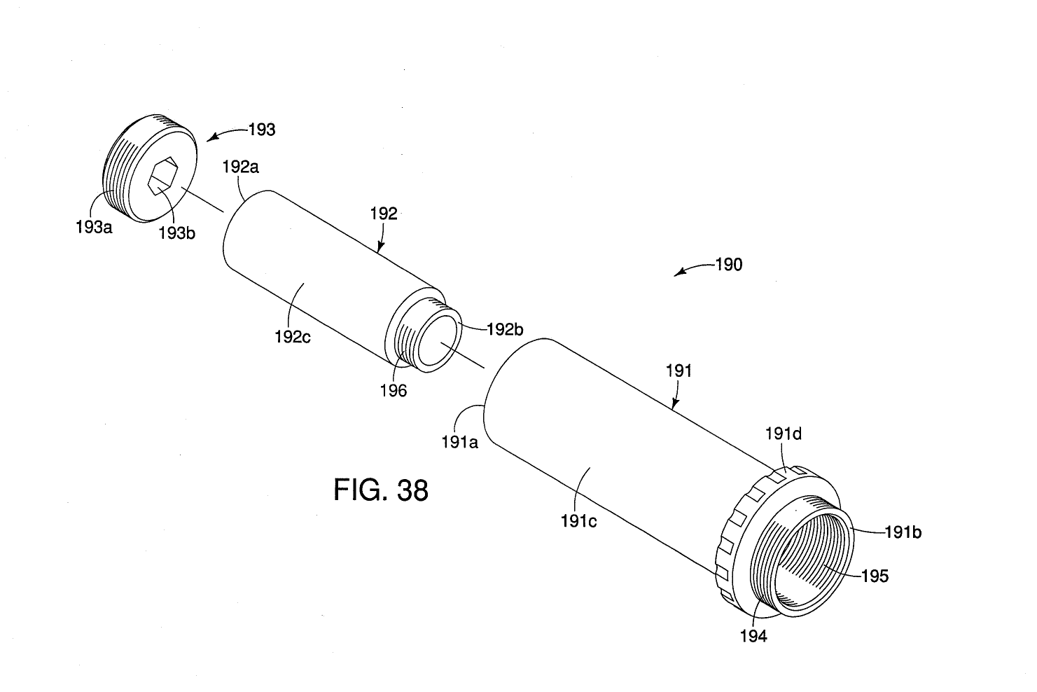

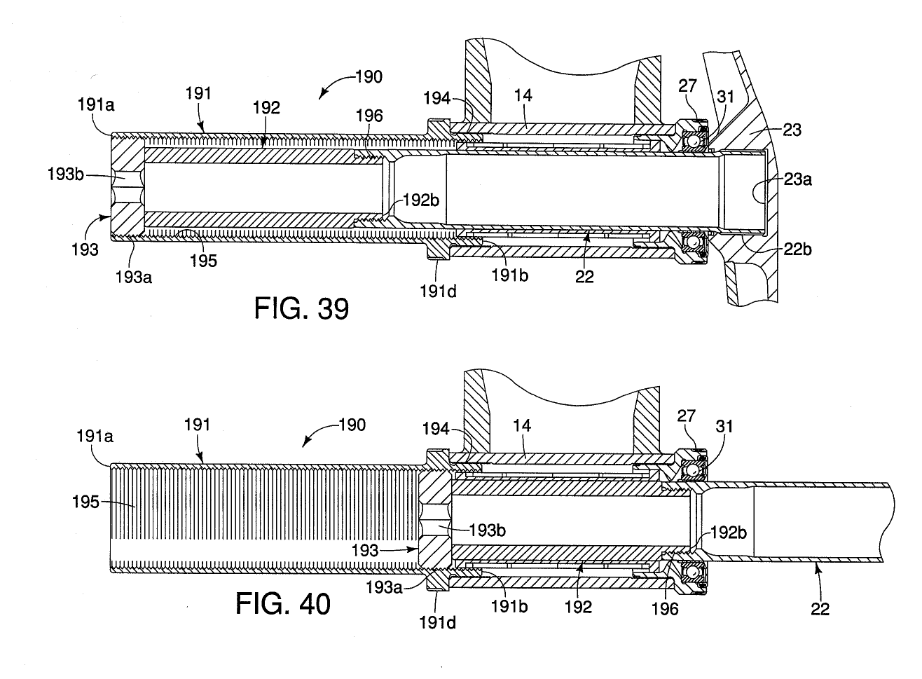

Referring now to FIGS. 38 to 48, a torque sensor deinsertion tool 190 is illustrated for removing the torsion-detecting sleeve member 40 (the torsion sensor unit) from the crank axle 22. The torque sensor deinsertion tool 190 basically includes an outer member 191, an inner member 192 and a nut member 193. Basically, the inner member 192 is threaded into the threaded hole 33 of the crank axle 22 to act as an extension of the crank axle 22. Then the outer member 191 is threaded into the hanger part 14, once the second threaded adapter 28 and the cylindrical mounting member 29 are removed. Finally, the nut member 193 is threaded into the outer member 191 to apply a pressing force on the inner member 192, which is acting as an extension of the crank axle 22. This pressing force pushes the crank axle out of the hanger part 14 and the torsion-detecting sleeve member 40. Thus, the torsion-detecting sleeve member 40 is positioned between the outer and inner members 191 and 192.

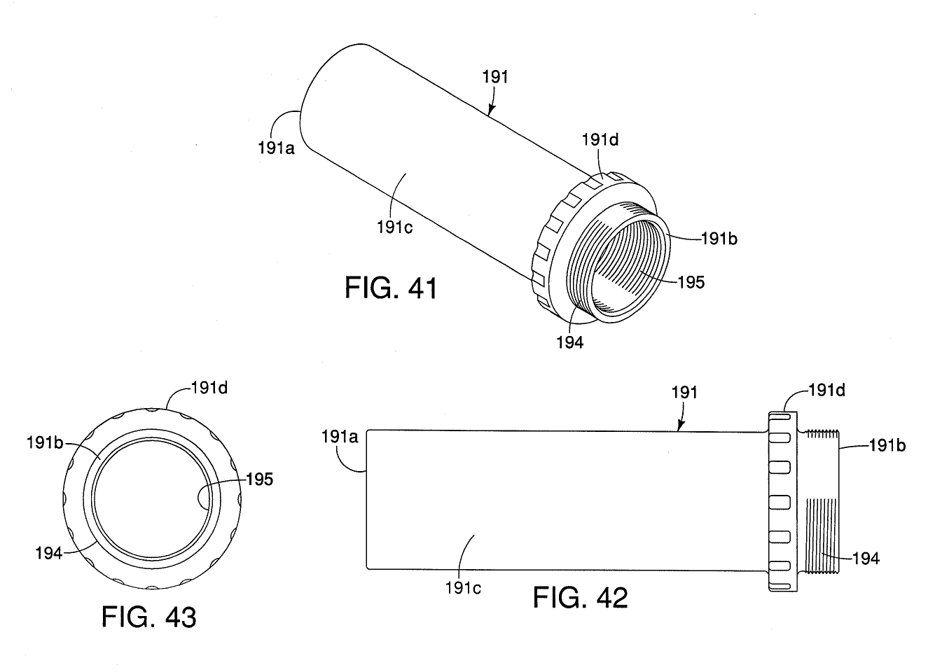

As best seen in FIGS. 41 to 43, the outer member 191 basically includes a first end 191a, a second end 191b and a tube portion 191c extending between the first and second ends 191a and 191b. The outer surface of the tube portion 191c has a bottom bracket engagement portion 191d adjacent the second end 191b. The bottom bracket engagement portion 191d includes an external thread 194 formed on the outer surface of the tube portion 191c along the bottom bracket engagement portion 191d from the second end 191b.

The bottom bracket engagement portion 191d includes an annular flange for receiving a tool or for being gripped by a user's hand to thread the outer member 191 into the hanger part 14. This flange of the bottom bracket engagement portion 191d also abuts against the hanger part 14 when the outer member 191 is completely attached to the hanger part 14. The outer member 191 has an internal tubular surface with an internal thread 195. The outer member 191 is a hard rigid member that is formed as a one-piece, unitary member from a suitable material such as a metallic material.

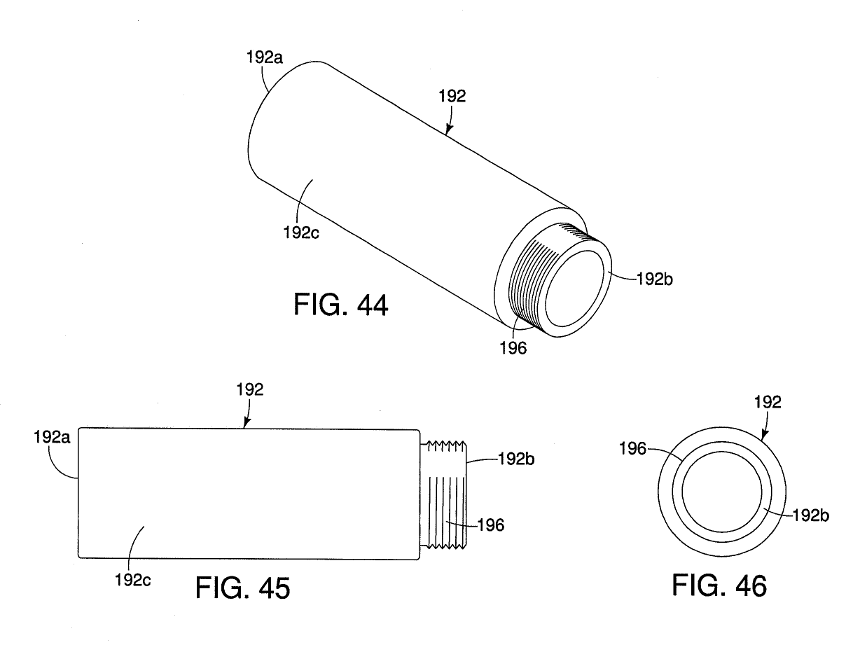

As best seen in FIGS. 44 to 46, the inner member 192 basically includes a first end 192a, a second end 192b and a tube portion 192c extending between the first and second ends 192a and 192b. The outer periphery surface of the inner member 192 is stepped with the large diameter portion extending from the first end 192a and the small diameter portion extending from the second end 192b. The small diameter portion of the tube portion 192c has an external thread 196 for threadedly engaging the threaded hole 33. The inner member 192 is disposed within the outer member 191 when the torque sensor deinsertion tool 190 is assembled in a torque sensor deinsertion arrangement. The outer periphery surface of the inner member 192 has a diameter that is dimensioned relative to the internal tubular surface of the outer member 191 to form a predetermined annular sensor receiving space therebetween for receiving the torsion-detecting sleeve member 40 when in the torque sensor deinsertion arrangement. The inner member 192 is a hard rigid member that is formed as a one-piece, unitary member from a suitable material such as a metallic material.

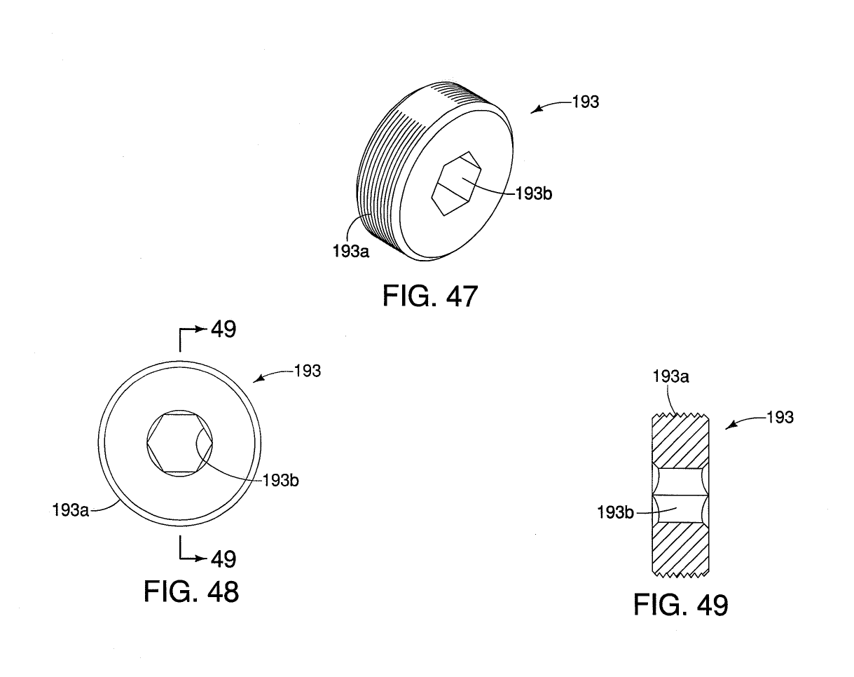

As best seen in FIGS. 47 to 49, the nut member 193 basically includes an external thread 193a and a tool engagement hole 193b. The external thread 193a is threadedly engaged with the internal thread 195 of the outer member 191 for axially pushing the inner member 192 within the outer member 191. The nut member 193 contacting the first end 192a of the inner member 192 when in the torque sensor deinsertion arrangement. The nut member 193 is a hard rigid member that is formed as a one-piece, unitary member from a suitable material such as a metallic material.

### GENERAL INTERPRETATION OF TERMS

In understanding the scope of the present invention, the term “configured” as used herein to describe a component, section or portion of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “portion,” “section,” “portion,” “member” or “element” when used in the singular can have the dual meaning of a single portion or a plurality of parts. As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention as used in the normal riding position. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A torque sensor insertion tool for installing a torque sensor unit disposed on an axle comprising:
an axle attachment structure including a first guide portion, a sensor supporting portion configured to support an inner surface of the torque sensor unit, and an axle attachment portion configured to fix the axle thereto;
a tubular sensor supporting structure including a first axial connecting portion, a first sensor abutment surface facing in a first axial direction for contacting a first abutment portion of the torque sensor unit, and a first tube portion having a first internal bore with an inner width dimensioned relative to an outer width of the axle attachment structure to form a predetermined annular sensor receiving space therebetween for receiving the torque sensor unit when the axle attachment structure is located in the first internal bore; and
a tubular sensor moving structure including a second guide portion configured to coaxially mate with the first guide portion, a second axial connecting portion for operatively engaging the first axial connecting portion to effectively interconnect the tubular sensor moving structure with the tubular sensor supporting structure to transmit an insertion force therebetween during insertion of the torque sensor unit on the axle, a second tube portion having a second internal bore to receive a portion of the axle attachment structure therein, and a second sensor abutment surface arranged to abut against the torque sensor unit when the torque sensor insertion tool is assembled in a torque sensor insertion arrangement.

2. The torque sensor insertion tool according to claim 1, wherein
the first and second guide portions include mating threads.

3. The torque sensor insertion tool according to claim 2, wherein
the mating thread of the first guide portion is an external thread and the mating thread of the second guide portion is an internal thread.

4. The torque sensor insertion tool according to claim 3, wherein
the second guide portion is a separate and distinct piece from the second tube portion, with the second guide portion having a force transmitting surface facing axially towards a force transmitting surface of the second tube portion when the torque sensor insertion tool is assembled in the torque sensor insertion arrangement.

5. The torque sensor insertion tool according to claim 4, wherein
the tubular sensor moving structure further includes a washer disposed between the force transmitting surfaces of the second guide portion and the second tube portion, with the washer having a non-rotatable connection with the axle attachment structure.

6. The torque sensor insertion tool according to claim 3, wherein
the second guide portion is integrally formed with the second tube portion as a one-piece, unitary member.

7. The torque sensor insertion tool according to claim 1, wherein
the first and second axial connecting portions include mating threads.

8. The torque sensor insertion tool according to claim 7, wherein
the mating thread of the first axial connecting portion is an internal thread and the mating thread of the second guide portion is an external thread.

9. The torque sensor insertion tool according to claim 8, wherein
the first axial connecting portion is a separate and distinct piece from the first tube portion, with the first axial connecting portion having a force transmitting surface contacting a force transmitting surface of the first tube portion when the torque sensor insertion tool is assembled in the torque sensor insertion arrangement.

10. The torque sensor insertion tool according to claim 8, wherein
the first axial connecting portion is integrally formed with the first tube portion as a one-piece, unitary member.

11. The torque sensor insertion tool according to claim 9, wherein
the first guide portion includes an external thread and the second guide portion includes an internal thread that is threadedly engaged with the external thread of the first guide portion.

12. A torque sensor deinsertion tool for removing a torque sensor unit disposed on an axle comprising:
an outer member including a first end, a second end with a bottom bracket engagement portion and an internal tubular surface with an internal thread;
an inner member including a first end and a second end with an external thread, the inner member being disposed within the outer member when the torque sensor deinsertion tool is assembled in a torque sensor deinsertion arrangement; and
a nut member including an external thread threadedly engaged with the internal thread of the outer member, with the nut member contacting the first end of the inner member when in the torque sensor deinsertion arrangement.

13. The torque sensor deinsertion tool according to claim 12, wherein
the bottom bracket engagement portion includes an external thread.

14. The torque sensor deinsertion tool according to claim 13, wherein
the bottom bracket engagement portion includes an axially facing surface located adjacent to the external thread of the bottom bracket engagement portion.

15. The torque sensor deinsertion tool according to claim 14, wherein
the inner member further includes an outer periphery surface with a diameter dimensioned relative to the internal tubular surface of the outer member to form a predetermined annular sensor receiving space therebetween for receiving a torque sensor unit when in the torque sensor deinsertion arrangement.
